(19) United States
(12) Patent Application Publication
(10) Pub. No.: US 2011/0026887 A1
(43) Pub. Date: Feb. 3, 2011

(54) MOUNTING STRUCTURE

(75) Inventors: Hiroshi Uemura, Yokohama-shi (JP); Hideto Furuyama, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/726,479

(22) Filed: Mar. 18, 2010

(30) Foreign Application Priority Data
Jul. 28, 2009 (JP) 2009-175554

(51) Int. Cl. G02B 6/43

(52) U.S. Cl. 385/88

(57) ABSTRACT

In a mounting structure formed by mounting an optoelectronic interconnection module on a mounting board, an optical semiconductor device, electrical wires and electrical connection terminals are provided on the main surface of an optoelectronic interconnection board having flexibility on the optoelectronic interconnection module and an optical interconnection path is provided at the optoelectronic interconnection board. Electrical wires and electrical connection terminals are provided on the main surface of the mounting board. A conductive connection member is disposed between the electrical connection terminals on the optoelectronic interconnection module side and the electrical connection terminals on the mounting board side. A heat release member that releases heat of the optical semiconductor device to the mounting board side is disposed between the optical semiconductor device and the mounting board.

### CROSS-REFERENCE TO RELATED APPLICATIONS

This application is based upon and claims the benefit of priority from prior Japanese Patent Application No. 2009-175554, filed Jul. 28, 2009, the entire contents of which are incorporated herein by reference.

### BACKGROUND

Recently, it is still more required to suppress noises and increase the operation speed of a signal transfer operation between LSI chips in a mobile communication device such as a personal computer or mobile phone. Along with this, much attention is paid to an optoelectronic interconnection that has an optical interconnection and electrical wire combined and has a feature of low noise and high speed.

As the optoelectronic interconnection, an optoelectronic interconnection array having optical fibers and electrical wires bundled and a flexible optoelectronic interconnection board having an optical waveguide formed on a flexible electrical wiring board (flexible printed circuit [FPC]) are provided. It is advantageous to use an optoelectronic interconnection module having electronic components such as optical semiconductor devices and driver ICs mounted on the flexible optoelectronic interconnection board from the viewpoint of the cost and performance. Conventionally, as a technique for providing a mounting structure having a module of an electrical wiring board mounted on a mounting board on which a display panel and LSI are mounted, a technique described in JP-A 2006-210809 (KOKAI) is known.

The electronic components such as optical devices and driver ICs of the optoelectronic interconnection module consume large currents and generate heat, but if the same structure as the mounting structure described in JP-A 2006-210809 (KOKAI) is used, heat release of the electronic components is insufficient. This leads to a factor that degrades the performance and reliability of the module.

### SUMMARY

According to one aspect of this invention, there is provided a mounting structure comprising:

an optoelectronic interconnection module that comprises an optoelectronic interconnection board having flexibility, an optical interconnection path formed on the optoelectronic interconnection board, electrical wires formed on a main surface of the optoelectronic interconnection board, an optical semiconductor device mounted on the main surface of the optoelectronic interconnection board and optically coupled with the optical interconnection path, and electrical connection terminals that are formed on the main surface of the optoelectronic interconnection board to electrically connect the electrical wires to an exterior,

a mounting board having electrical wires and electrical connection terminals used to electrically connect the electrical wires to the exterior formed on a main surface thereof and having the optoelectronic interconnection module mounted thereon with the main surface thereof set to face the main surface of the optoelectronic interconnection board,

a conductive connection member provided between the electrical connection terminals of the optoelectronic interconnection module and the electrical connection terminals of the mounting board to electrically connect the electrical connection terminals of the optoelectronic interconnection module to the electrical connection terminals of the mounting board, and

a heat release member provided between the optical semiconductor device and the mounting board to release heat of the optical semiconductor device to the mounting board side.

According to another aspect of this invention, there is provided a mounting structure comprising:

an optoelectronic interconnection module that comprises an optoelectronic interconnection board having flexibility, an optical interconnection path formed on the optoelectronic interconnection board, electrical wires formed on a main surface of the optoelectronic interconnection board, an optical semiconductor device mounted on the main surface of the optoelectronic interconnection board and optically coupled with the optical interconnection path, a driver IC that is mounted on the main surface of the optoelectronic interconnection board and drives the optical semiconductor device, and electrical connection terminals that are formed on the main surface of the optoelectronic interconnection board to electrically connect the electrical wires to an exterior,

a mounting board having electrical wires and electrical connection terminals used to electrically connect the electrical wires to the exterior formed on a main surface thereof and having the optoelectronic interconnection module mounted thereon with the main surface thereof set to face the main surface of the optoelectronic interconnection board,

a conductive connection member provided between the electrical connection terminals of the optoelectronic interconnection module and the electrical connection terminals of the mounting board to electrically connect the electrical connection terminals of the optoelectronic interconnection module to the electrical connection terminals of the mounting board, and

a heat release member provided between at least one of the driver IC and optical semiconductor device and the mounting board to release heat of at lest one of the driver IC and optical semiconductor device to the mounting board side.

### BRIEF DESCRIPTION OF THE DRAWING

FIG. 1 is a perspective view showing the schematic structure of a mounting structure according to a first embodiment of this invention.

FIG. 2 is a perspective view showing an example of an optoelectronic interconnection module used in the first embodiment.

FIG. 3 is a perspective view showing another example of the optoelectronic interconnection module used in the first embodiment.

FIG. 4 is a perspective view showing still another example of the optoelectronic interconnection module used in the first embodiment.

FIG. 5 is a perspective view showing an example of a mounting board used in the first embodiment.

FIGS. 6A, 6B are a cross-sectional view and plan view showing the structure of a main portion of the mounting structure according to the first embodiment.

FIGS. 7A, 7B are a cross-sectional view and plan view showing the structure of a main portion of a mounting structure according to a second embodiment of this invention.

FIGS. 8A, 8B are a cross-sectional view and plan view showing the structure of a main portion of a mounting structure according to a third embodiment of this invention.

FIGS. 9A, 9B are a cross-sectional view and plan view showing the structure of a main portion of a mounting structure according to a fourth embodiment of this invention.

FIGS. 10A, 10B are cross-sectional views showing the structure of a main portion of a mounting structure according to a modification of this invention.

### DETAILED DESCRIPTION

Now, this invention will be explained in detail with reference to embodiments shown in the accompanying drawings.

### First Embodiment

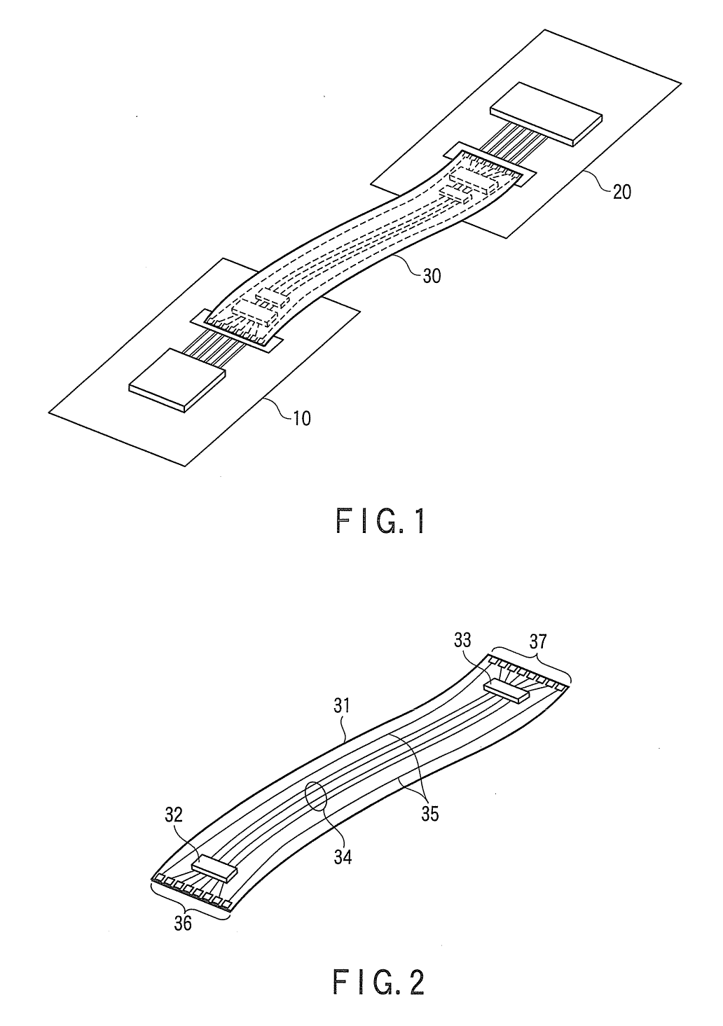

FIG. 1 is a perspective view showing the schematic structure of a mounting structure according to a first embodiment of this invention.

An optoelectronic interconnection module 30 having driver ICs, optical semiconductor devices, optical interconnection path and electrical wires is provided between a first mounting board 10 having LSIs and electrical wires and a second mounting board 20 having LSIs and electrical wires.

As shown in FIG. 2, the optoelectronic interconnection module 30 comprises a flexible optoelectronic interconnection board 31, a light-emitting element 32 as an optical semiconductor device, a light-receiving element 33 as an optical semiconductor device, optical interconnection path 34, electrical wires 35 and electrical connection terminals 36, 37. The electrical wires 35 and electrical connection terminals 36, 37 are formed on the main surface of the flexible optoelectronic interconnection board 31 and the light-emitting element 32 and light-receiving element 33 are mounted on the main surface of the flexible optoelectronic interconnection board 31. A part of the main surface of the flexible optoelectronic interconnection board 31 may be covered with a protective layer such as a cover layer or solder resist.

The flexible optoelectronic interconnection board 31 has flexibility. For example, the electrical wires 35 can be formed by patterning a copper foil laminated on a base film formed of a polyimide film. For example, the optical interconnection path 34 can be formed by laminating an optical waveguide film formed of acryl resin or epoxy resin on the surface of the polyimide film that is opposite to the surface on which the electrical wires 35 are formed. Specifically, as the optical waveguide film, a first optical waveguide clad and optical waveguide core are sequentially laminated and a second optical waveguide clad is laminated after the optical waveguide core is patterned to form an optical interconnection path. Since the optical waveguide core has a refractive index higher than that of the first and second optical waveguide clads and is patterned and buried in the optical waveguide clads, an optical signal is confined and propagated along the optical waveguide core. Further, mirrors (not shown) capable of extracting an optical signal propagated along the optical waveguide core in a direction perpendicular to the main surface of the optoelectronic interconnection board 31 are formed on both ends of the optical waveguide core.

The light-emitting element 32 such as a light-emitting diode or semiconductor laser is mounted on the main surface of the optoelectronic interconnection board 31 near one end portion and the light-receiving element 33 such as a photodiode is mounted on the main surface thereof near the other end portion. The light-emitting element 32 and light-receiving element 33 are arranged on the mirrors formed on both ends of the optical interconnection path 34 and optically coupled. Further, electrical terminals (not shown) of the light-emitting element 32 and light-receiving element 33 are mounted on the electrical wires 35 and electrically connected to the exterior of the optoelectronic interconnection module. Thus, an optical signal transfer operation can be performed by inputting and outputting an electrical signal.

The electrical wires 35 are provided between one end and the other end of the optoelectronic interconnection board 31 on the main surface of the optoelectronic interconnection board 31. Further, the first electrical connection terminals 36 are provided on the main surface of the optoelectronic interconnection board 31 on one end side and electrically connected to the light-emitting element 32. The second electrical connection terminals 37 are provided on the main surface of the optoelectronic interconnection board 31 on the other end side and electrically connected to the light-receiving element 33. Further, as shown in FIG. 2, portions of the electrical connection terminals 36, 37 may be electrically connected via the electrical wires 35.

In the above example, the light-emitting element 32 is provided on one end side of the optoelectronic interconnection board 31, the light-receiving element 33 is provided on the other end side thereof and the signal transfer direction is set to a single direction. However, the light-emitting elements 32 and light-receiving elements 33 are provided on both end sides thereof to perform a bi-directional transfer operation.

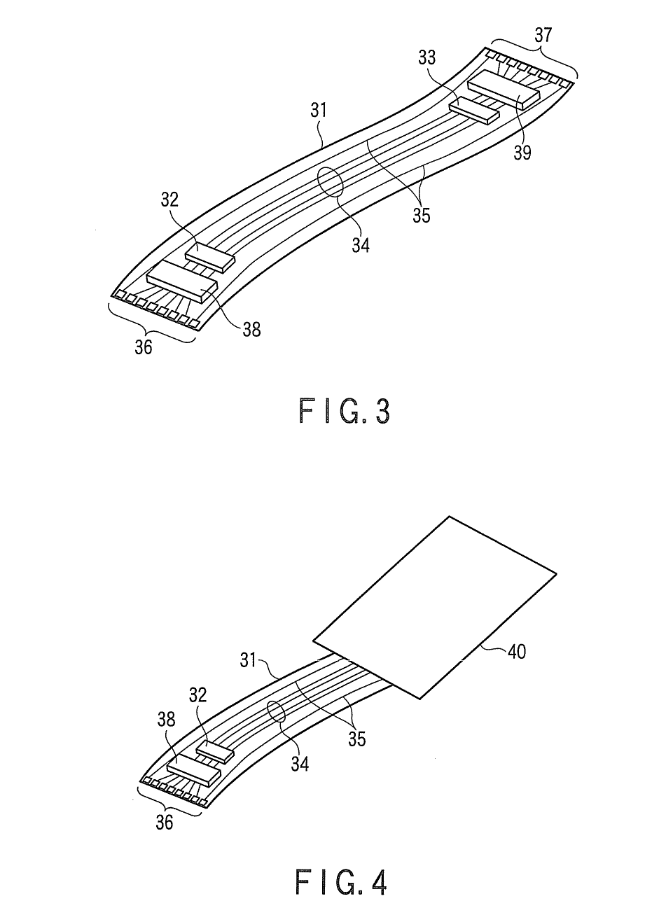

FIG. 3 shows another example of the optoelectronic interconnection module 30 and driver ICs are provided on the main surface of the optoelectronic interconnection board 31 in addition to the structure shown in FIG. 2. That is, a first driver IC 38 used to drive the light-emitting element 32 is provided between the light-emitting element 32 and the electrical connection terminals 36. Further, a second driver IC 39 used to drive the light-receiving element 33 and amplify an electrical signal received from the light-receiving element 33 is provided between the light-receiving element 33 and the electrical connection terminals 37.

The first and second driver ICs 38, 39 may be configured by different driver ICs or may be configured by the same driver IC comprising both of a circuit that drives the light-emitting element 32 and a circuit that drives the light-receiving element 33. When the light-emitting elements 32 and light-receiving elements 33 are provided on both end sides of the optoelectronic interconnection board 31 to perform a bi-directional transfer operation in a case where the first and second driver ICs 38, 39 are configured by different driver ICs, it is necessary to provide the first and second driver ICs 38, 39 on both end sides of the optoelectronic interconnection board 31. Further, when the light-emitting elements 32 and light-receiving elements 33 are provided on both end sides of the optoelectronic interconnection board 31 to perform a bi-directional transfer operation in a case where the driver ICs are configured by the same driver IC, it is possible to provide one of the first driver ICs 38 and second driver ICs 39 on both end sides of the optoelectronic interconnection board 31 so as to drive both of the light-emitting elements 32 and light-receiving elements 33. Each of the first and second driver ICs 38, 39 may comprise another circuit in addition to the drive circuit for the light-emitting elements 32 or light-receiving elements 33.

FIG. 4 shows still another example of the optoelectronic interconnection module 30 and one-side ends or the other ends of the optoelectronic interconnection module 30 is directly connected to a module 40. As a connection method of the optoelectronic interconnection module 30 and module 40, for example, a method for connecting the module 40 to the optoelectronic interconnection module 30 via the electrical connection terminals 36, 37 of the optoelectronic interconnection module 30 may be used. Alternatively, the optical interconnection path 34 and electrical wires 35 of the optoelectronic interconnection module 30 may be directly connected to an optical interconnection path and electrical wires of the module 40. As the module 40, for example, a display, camera and a board having LSIs mounted thereon are provided.

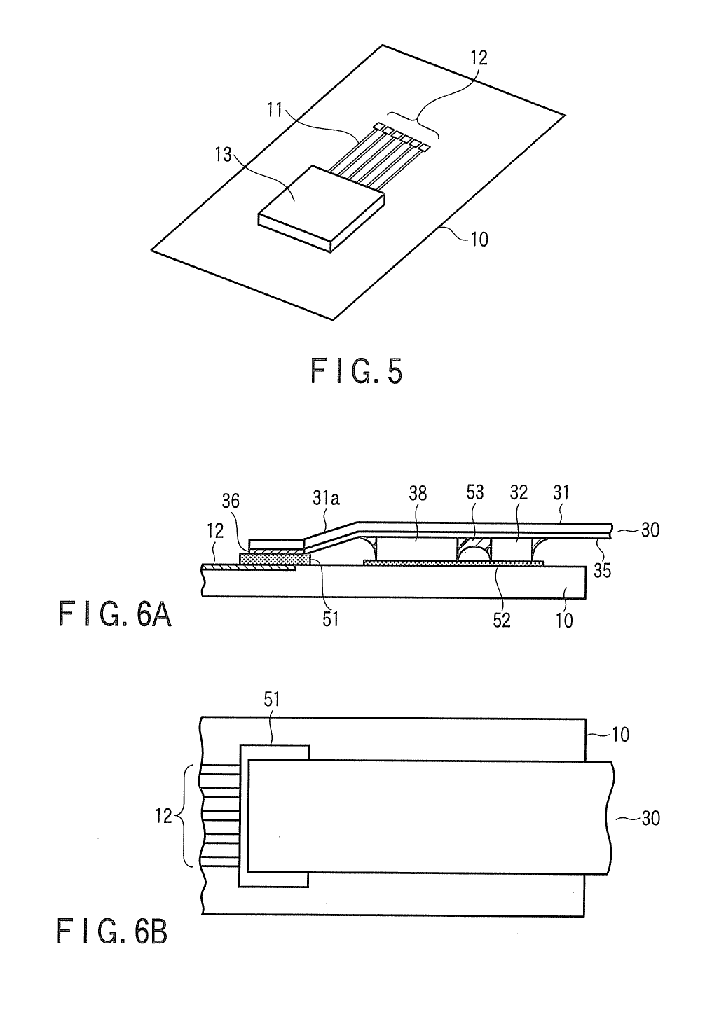

As shown in FIG. 5, the first mounting board 10 comprises electrical wires 11 and electrical connection terminals 12 that electrically connect the electrical wires 11 to the exterior on the main surface thereof. An LSI 13 such as a CPU electrically connected to the electrical wires 11 may be mounted on the main surface of the mounting board 10. Further, instead of the LSI 13, a module such as a display or camera may be connected and mounted. Although not shown in the drawing, the second mounting board 20 is formed with the same structure as that of the first mounting board 10.

FIGS. 6A, 6B show the structure of a main portion of the mounting structure according to this embodiment, FIG. 6A being a cross-sectional view and FIG. 6B being a plan view. The drawing shows an example in which the optoelectronic interconnection module in FIG. 3 or 4 is used and shows a connection portion on one end side of the optoelectronic interconnection module 30.

One end portion of the optoelectronic interconnection module 30 is mounted on the mounting board 10 with the main surface of the optoelectronic interconnection board 31 set to face the main surface of the first mounting board 10. Although not shown in the drawing, the other end portion of the optoelectronic interconnection module 30 may be mounted on the mounting board 20 with the main surface of the optoelectronic interconnection board 31 set to face the main surface of the second mounting board 20 or may be mounted on the mounting board 20 by use of another method. Since the connection relations of the mounting boards 10, 20 with respect to the optoelectronic interconnection module 30 are the same, only a connection on one end portion of the optoelectronic interconnection module 30 is explained below.

The surfaces of the light-emitting element 32 and driver IC 38 of the optoelectronic interconnection module 30 make contact with the main surface of the mounting board 10 with a heat release member 52 disposed therebetween. As the heat release member 52, it is desirable to use a material having thermal conductivity higher than mean thermal conductivity of the optoelectronic interconnection board 31 and, for example, a thermally conductive sheet formed of silicone resin or graphite, thermally conductive resin or heat release grease can be used. In this embodiment, a thermally conductive sheet is used as the heat release member 52. As the heat release member 52, a thermally conductive sheet having adhesive surfaces on both surfaces or thermally conductive resin having a thermosetting property or ultraviolet-curable property may be used. When using the above material, it becomes possible to not only form a heat release path from the light-emitting element 32 and driver IC 38 to the mounting board 10 but also secure the light-emitting element 32 and driver IC 38 to the mounting board 10 to hold the heat release path. In this configuration, a reinforcing member 53 formed of, for example, under-fill resin is provided on the bottom surfaces of the light-emitting element 32 and driver IC 38 (the surfaces of the light-emitting element 32 and driver IC 38 that lie on the main surface side of the optoelectronic interconnection board 31) and on the side surfaces of the light-emitting element 32 and driver IC 38.

When an amount of heat radiation of the light-emitting element 32 is sufficiently smaller than that of the driver IC 38, the heat release member 52 may be provided only between the driver IC 38 and the mounting board 10. On the contrary, when an amount of heat radiation of the driver IC 38 is sufficiently smaller than that of the light-emitting element 32, the heat release member 52 may be provided only between the light-emitting element 32 and the mounting board 10.

Thus, highly efficient heat release of the light-emitting element 32 and driver IC 38 of the optoelectronic interconnection module 30 can be achieved by connecting the light-emitting element 32 and driver IC 38 of the optoelectronic interconnection module 30 to the mounting board 10 via the heat release member 52. In this case, by forming an island-form metal area with substantially the same size as that of the light-emitting element 32 and driver IC 38 on the surface portion of the mounting board 10 and connecting the metal area to a ground wire or the like by using a via or the like, the thermal capacity of the metal area can be increased and heat release can be further increased.

The electrical connection terminals 36 of the optoelectronic interconnection module 30 and the electrical connection terminals 12 of the mounting board 10 are electrically connected via a connection member 51 and secured. Thus, the connection can be achieved at lower cost in comparison with a case wherein two types of electrical connection terminals are electrically connected and secured by means of connector components or wire bonding.

When thermocompressed, the connection member 51 forms a conduction path and is cured and an anisotropic conductive film (ACF) or anisotropic conductive paste (ACP) may be used as the connection member. By using the above film, only the electrical connection terminals that face each other can be made conductive and two types of electrical connection terminals can be secured and kept conductive by pressing the optoelectronic interconnection module 30 towards the mounting board 10 while heating the same after the electrical connection terminals 12, 36 are aligned.

The connection member 51 may have an ultraviolet-curable property. Further, securing of the optoelectronic interconnection module 30 to the mounting board 10 can be achieved not by means of the connection member 51 but by means of a different mechanism (by using a mechaclamp [screwing] or different curable resin or using an adhesive tape).

A bent portion 31a is provided near the end portion of the optoelectronic interconnection board 31. By the presence of the bent portion 31a, a portion in which the electrical connection terminals 36 are provided can be arranged closer to the mounting board 10 than the mounting portion of the light-emitting element 32 and driver IC 38. Therefore, the connection member 51 can be made thin and a connection can be made by means of the connection member 51 of low cost. In this case, a connection member with substantially the same thickness as that of the light-emitting element 32 and driver IC 38 can be used instead of the bent portion 31a.

Thus, according to this embodiment, in the optoelectronic interconnection module 30 having the optical semiconductor device and driver IC provided thereon, the optical semiconductor device and driver IC are set to face the mounting board 10, the electrical connection terminals 12, 36 are connected via the connection member 51 and the optical semiconductor device and driver IC are connected to the mounting board 10 via the heat release member 52. Thus, heat release of the electronic components of the optoelectronic interconnection module 30 mounted on the mounting board 10 can be made highly efficient and the reliability thereof can be increased. Therefore, the mounting structure of low cost and highly efficient heat release in which the optoelectronic interconnection module is mounted on the mounting board can be realized and the cost of the information communication device can be reduced and the performance thereof can be further increased.

### Second Embodiment

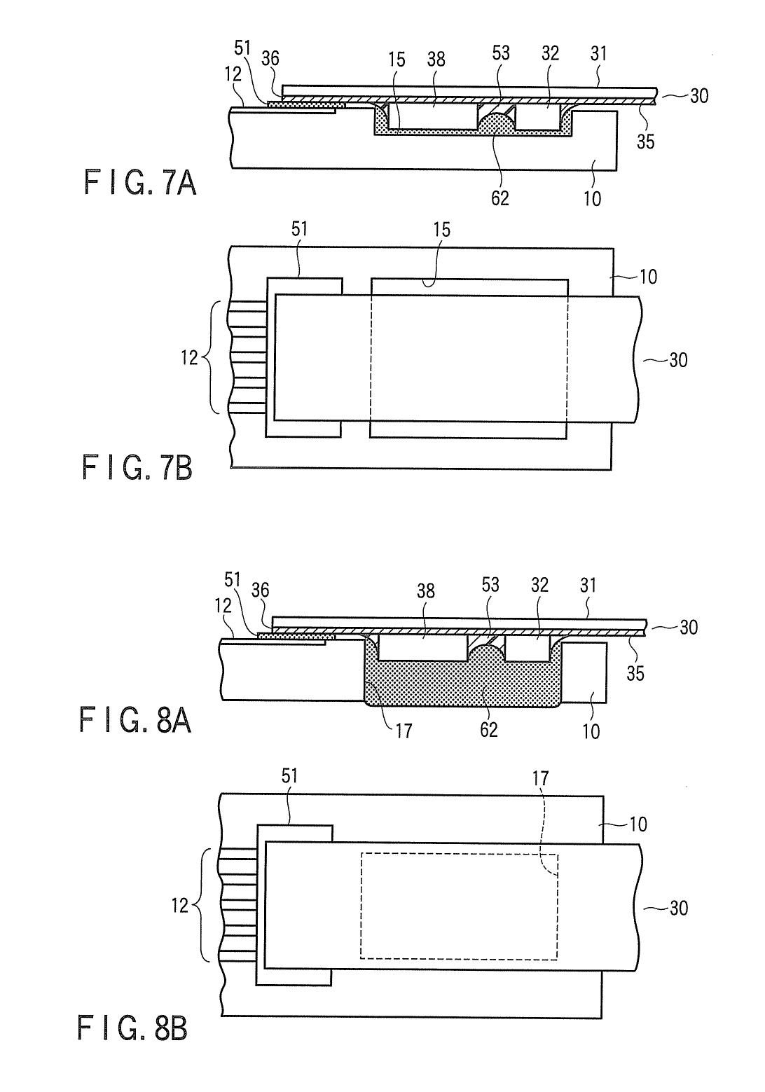

FIGS. 7A, 7B illustrate the structure of a main portion of a mounting structure according to a second embodiment of this invention, FIG. 7A being a cross-sectional view and FIG. 7B being a plan view. Portions that are the same as those of FIGS. 6A, 6B are denoted by the same symbols and the detailed explanation thereof is omitted.

This embodiment is different from the first embodiment explained before in that a concave portion 15 in which an optical semiconductor device and driver IC are received is formed in a mounting board 10. That is, the concave portion 15 with a larger area than that of a light-emitting element 32 and driver IC 38 is formed in a position facing the light-emitting element and driver IC on the main surface of the mounting board 10. A heat release member 62 such as a thermally conductive sheet or heat release grease is disposed on the bottom surface of the concave portion 15. The light-emitting element 32 and driver IC 38 are formed in contact with at least the bottom surface of the concave portion 15 with the heat release member 62 disposed therebetween.

When heat release grease is used as the heat release member 62, the light-emitting element 32 and driver IC 38 are inserted into the concave portion 15 with the heat release member 62 filled in the concave portion 15. Thus, the heat release member 62 is pressed by the light-emitting element 32 and driver IC 38 and a part thereof is moved to the side surfaces of the concave portion 15. Therefore, the light-emitting element 32 and driver IC 38 are connected to the mounting board 10 on the side surfaces of the concave portion 15 with the heat release member 62 disposed therebetween. The heat release member 62 may have a thermosetting property or ultraviolet-curable property.

With the above structure, the same effect as that of the first embodiment described before can of course be achieved, the bent portion 31a of the optoelectronic interconnection board 31 can be made unnecessary and stress applied to the optoelectronic interconnection board 31 can be alleviated.

It is desirable to set the width (in the vertical direction in the top view) of the concave portion 15 larger than the width of the optoelectronic interconnection board 31. If the width of the concave portion 15 is set larger than the width of the optoelectronic interconnection board 31, heat release from the heat release member 62 into air can be achieved. Further, the heat release member 62 can be filled into the concave portion after the light-emitting element 32 and driver IC 38 are received into the concave portion 15.

### Third Embodiment

FIGS. 8A, 8B illustrate the structure of a main portion of a mounting structure according to a third embodiment of this invention, FIG. 8A being a cross-sectional view and FIG. 8B being a plan view. Portions that are the same as those of FIGS. 6A, 6B and FIGS. 7A, 7B are denoted by the same symbols and the detailed explanation thereof is omitted.

This embodiment is different from the first embodiment explained before in that a penetration hole 17 in which an optical semiconductor device and driver IC are received is formed in a mounting board 10. That is, the penetration hole 17 with a larger area than that of a light-emitting element 32 and driver IC 38 is formed in a position facing the light-emitting element and driver IC on the main surface of the mounting board 10. A heat release member 62 is formed to fill the penetration hole 17. The optical semiconductor device and driver IC are formed in contact with the side surfaces of the penetration hole 17 with the heat release member 62 disposed therebetween.

With the above structure, like the second embodiment described before, the bent portion 31a of the optoelectronic interconnection board 31 can be made unnecessary and stress applied to the optoelectronic interconnection board 31 can be alleviated.

It is desirable to set the width (in the vertical direction in FIG. 8B) of the penetration hole 17 smaller than the width of the optoelectronic interconnection board 31. If the width of the former is set smaller than the width of the latter, the heat release member 62 such as heat release grease having fluidity can be injected from the back surface (undersurface in the cross-sectional view) of the penetration hole 17 of the mounting board 10 (to prevent the heat release member from overflowing).

Further, since heat release of the optical semiconductor device and driver IC can be achieved along the side surfaces of the penetration hole 17 of the mounting board 10, the heat release member 62 is not necessarily required to be filled into the entire portion of the penetration hole 17 and it is sufficient to provide the heat release member at lest on the side surfaces of the penetration hole 17.

### Fourth Embodiment

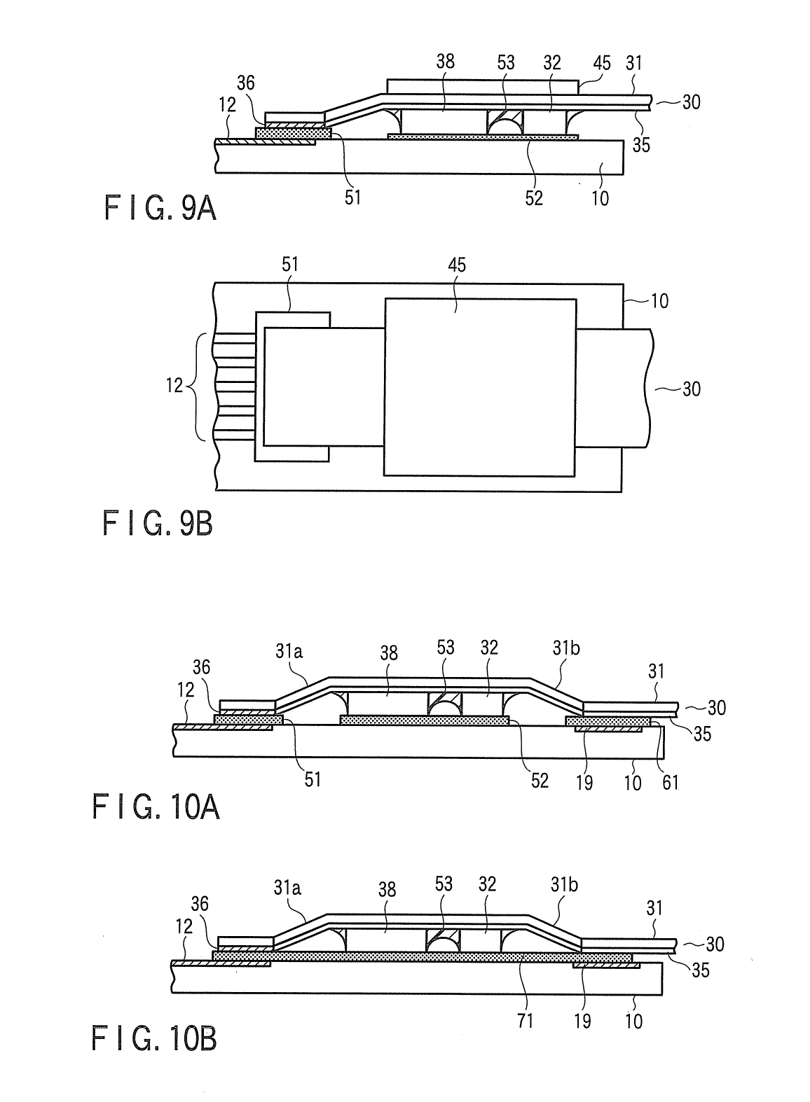

FIGS. 9A, 9B illustrate the structure of a main portion of a mounting structure according to a fourth embodiment of this invention, FIG. 9A being a cross-sectional view and FIG. 9B being a plan view. Portions that are the same as those of FIGS. 6A, 6B are denoted by the same symbols and the detailed explanation thereof is omitted.

This embodiment is different from the first embodiment explained before in that a copper tape 45 is used to stably achieve a thermal and mechanical connection between an optoelectronic interconnection module 30 and a mounting board 10. That is, the copper tape 45 having preferable thermal conductivity is attached to a portion of the back surface of an optoelectronic interconnection board 31 that corresponds to the back surface of a portion of the main surface thereof on which a light-emitting element 32 and driver IC 38 are disposed. Both end portions of the copper tape 45 are attached to the main surface of the mounting board 10. A tape using metal other than copper or thermally conductive resin having a thermal or ultraviolet-curable property can be used instead of the copper tape.

With the above structure, the same effect as that of the first embodiment described before can of course be achieved, heat release of the optoelectronic interconnection module 30 can be further increased and the mechanical connection strength between the optoelectronic interconnection module 30 and the mounting board 10 can be further increased.

### Modification

This invention is not limited to the above embodiments. In the embodiments, the electrical connection terminals 36 on the side of the optoelectronic interconnection module 30 and the electrical connection terminals 12 on the side of the mounting board 10 are connected in one portion via the connection member 51. Further, as shown in FIG. 10A, connections can be made in two portions. That is, electrical connection terminals 19 may be provided inside (on the side opposite to the electrical connection terminals 12) a portion facing the light-emitting element 32 and driver IC 38 on the main surface of the mounting board 10 together with the connection member 51 on the end portion of the optoelectronic interconnection board 31. Then, the electrical wires 35 of the optoelectronic interconnection board 31 and the electrical connection terminals 19 may be connected via a connection member 61 in the above connection portion. Further, at this time, a bent portion 31b that is the same as the bent portion 31a on one end side can be provided. As the connection member 61, ACF or ACP can be used like the connection member 51. The connection strength can be increased and the reliability of the electrical connection can be increased by connecting the optoelectronic interconnection module 30 to the mounting board 10 in two portions.

In an example of FIG. 10A, it is necessary to provide the connection member 61 in two portions. However, the electrical connection and thermal connection can be simultaneously realized by forming a connection member 71 to have a function of the heat release member 52. That is, as shown in FIG. 10B, the connection member 71 that is continuously formed to extend from the electrical connection terminals 12 to the electrical connection terminals 19 is disposed on the main surface of the mounting board 10. As a result, the electrical connection of the electrical connection terminals 36 and the thermal connection of the light-emitting element 32 and driver IC 38 can be simultaneously realized by means of the connection member 71.

In the embodiment of this invention, an example in which the optoelectronic interconnection board 31 having the electrical wires 35 and optical interconnection path 34 formed thereon by laminating the copper foil or optical waveguide film on the base film and patterning the above foil or film is used is shown. However, it is also possible to use a flexible optoelectronic interconnection board formed by discretely forming a flexible interconnection board having electrical wires formed thereon and a flexible interconnection board having an optical interconnection path formed thereon and laminating the flexible interconnection boards to form an integrated body. At this time, the optical semiconductor device and the driver IC that drives the optical semiconductor device may be mounted on the flexible interconnection board having the electrical wires formed thereon or mounted on the flexible interconnection board having the optical interconnection path formed thereon. Likewise, a flexible optoelectronic interconnection board obtained by mounting a flexible interconnection board having an optical interconnection path and electrical wires formed thereon on a flexible interconnection board having electrical wires formed thereon and integrating them can be used. Further, a flexible optoelectronic interconnection board obtained by mounting a flexible interconnection board having an optical interconnection path and electrical wires formed thereon on a flexible interconnection board having an optical interconnection path and electrical wires formed thereon and integrating them can be used.

The material of the heat release member is not limited to the thermally conductive sheet or heat release grease and can be adequately modified according to the specification. Likewise, the material of the connection member is not limited to ACF or ACP and can be adequately modified according to the specification. Further, the mounting structure is not limited to the structure obtained by connecting the two mounting boards via the optoelectronic interconnection module and may be a structure obtained by connecting the optoelectronic interconnection module as shown in FIG. 4 to one mounting board.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mounting structure comprising:
an optoelectronic interconnection module that comprises an optoelectronic interconnection board having flexibility, an optical interconnection path formed on the optoelectronic interconnection board, electrical wires formed on a main surface of the optoelectronic interconnection board, an optical semiconductor device mounted on the main surface of the optoelectronic interconnection board and optically coupled with the optical interconnection path, and electrical connection terminals that are formed on the main surface of the optoelectronic interconnection board to electrically connect the electrical wires to an exterior;
a mounting board having electrical wires and electrical connection terminals used to electrically connect the electrical wires to the exterior formed on a main surface thereof and having the optoelectronic interconnection module mounted thereon with the main surface thereof set to face the main surface of the optoelectronic interconnection board;
a conductive connection member provided between the electrical connection terminals of the optoelectronic interconnection module and the electrical connection terminals of the mounting board to electrically connect the electrical connection terminals of the optoelectronic interconnection module to the electrical connection terminals of the mounting board; and
a heat release member provided between the optical semiconductor device and the mounting board to release heat of the optical semiconductor device to the mounting board side.

2. The structure of claim 1, wherein the optoelectronic interconnection board comprises a bent portion and a distance from a portion in which the electrical connection terminals of the optoelectronic interconnection module are provided to the mounting board is shorter than a distance from a portion in which the optical semiconductor device is mounted to the mounting board.

3. The structure of claim 1, wherein a concave portion is formed in the main surface of the mounting board, the optical semiconductor device is disposed in the concave portion and the heat release member is provided on at least a bottom surface of the concave portion.

4. The structure of claim 1, wherein a penetration hole is formed in the main surface of the mounting board, the optical semiconductor device is disposed in the penetration hole and the heat release member is provided on at least side surfaces of the penetration hole.

5. The structure of claim 1, wherein the connection member is one of an anisotropic conductive film and anisotropic conductive paste that forms a conduction path.

6. The structure of claim 1, wherein the heat release member is a thermally conductive sheet having adhesive surfaces on both surfaces.

7. The structure of claim 1, wherein the heat release member is one of thermally conductive resin and heat release grease having one of a thermosetting property and ultraviolet-curable property.

8. The structure of claim 1, further comprising a tape that mechanically secures the optoelectronic interconnection board to the mounting board,
wherein the tape has a central portion adhered to a surface of the optoelectronic interconnection board opposite to the main surface thereof on which the optical semiconductor device is mounted and both ends adhered to the main surface of the mounting board.

9. The structure of claim 1, wherein a thickness of the connection member is larger than that of the heat release member.

10. A mounting structure comprising:
an optoelectronic interconnection module that comprises an optoelectronic interconnection board having flexibility, an optical interconnection path formed on the optoelectronic interconnection board, electrical wires formed on a main surface of the optoelectronic interconnection board, an optical semiconductor device mounted on the main surface of the optoelectronic interconnection board and optically coupled with the optical interconnection path, a driver IC that is mounted on the main surface of the optoelectronic interconnection board and drives the optical semiconductor device, and electrical connection terminals that are formed on the main surface of the optoelectronic interconnection board to electrically connect the electrical wires to an exterior;
a mounting board having electrical wires and electrical connection terminals used to electrically connect the electrical wires to the exterior formed on a main surface thereof and having the optoelectronic interconnection module mounted thereon with the main surface thereof set to face the main surface of the optoelectronic interconnection board;
a conductive connection member provided between the electrical connection terminals of the optoelectronic interconnection module and the electrical connection terminals of the mounting board to electrically connect the electrical connection terminals of the optoelectronic interconnection module to the electrical connection terminals of the mounting board; and
a heat release member provided between at least one of the driver IC and optical semiconductor device and the mounting board to release heat of at lest one of the driver IC and optical semiconductor device to the mounting board side.

11. The structure of claim 10, wherein the optoelectronic interconnection board comprises a bent portion and a distance from a portion in which the electrical connection terminals of the optoelectronic interconnection module are provided to the mounting board is shorter than a distance from a portion in which the optical semiconductor device is mounted to the mounting board and a distance from a portion in which the driver IC is mounted to the mounting board.

12. The structure of claim 10, wherein a concave portion is formed in the main surface of the mounting board, the optical semiconductor device and driver IC are disposed in the concave portion and the heat release member is provided on at least a bottom surface of the concave portion.

13. The structure of claim 10, wherein a penetration hole is formed in the main surface of the mounting board, the optical semiconductor device and driver IC are disposed in the penetration hole and the heat release member is provided on at least side surfaces of the penetration hole.

14. The structure of claim 10, wherein the connection member is one of an anisotropic conductive film and anisotropic conductive paste that forms a conduction path.

15. The structure of claim 10, wherein the heat release member is a thermally conductive sheet having adhesive surfaces on both surfaces.

16. The structure of claim 10, wherein the heat release member is one of thermally conductive resin and heat release grease having one of a thermosetting property and ultraviolet-curable property.

17. The structure of claim 10, further comprising a tape that mechanically secures the optoelectronic interconnection board to the mounting board,
wherein the tape has a central portion adhered to a surface of the optoelectronic interconnection board opposite to the main surface thereof on which the optical semiconductor device and driver IC are mounted and both ends adhered to the main surface of the mounting board.

18. The structure of claim 10, wherein thickness of the connection member is larger than that of the heat release member.
